(19) United States
(12) Patent Application Publication
(10) Pub. No.: US 2009/0123785 A1
(43) Pub. Date: May 14, 2009

(54) FUEL CELL SYSTEM AND CONTROL METHOD THEREFOR

(75) Inventors: Yasuyuki Muramatsu, Shizuoka (JP); Masatsugu Oishi, Miyagi (JP)

Correspondence Address: YAMAHA HATSUDOKI KABUSHIKI KAISHA;C/O KEATING & BENNETT, LLP, 1800 Alexander Bell Drive, SUITE 200, Reston, VA, 20191, US

(73) Assignee: YAMAHA HATSUDOKI KABUSHIKI KAISHA, Iwata-shi (JP)

(21) Appl. No.: 11/718,144

(22) PCT Filed: Oct. 24, 2005
(86) PCT No.: PCT/JP2005/019855

§ 371 Date: Jan. 22, 2009

(30) Foreign Application Priority Data
Oct. 28, 2004 (JP) 2004-313461

(51) Int. Cl. H01M 8/04

(52) U.S. Cl. 429/13; 429/22; 429/23

(57) ABSTRACT

A fuel cell system and a control method therefor are capable of improving power generation efficiency of the fuel cell more reliably during a normal operation. A fuel cell system is arranged along a vehicle frame of a motorcycle. The fuel cell system includes a fuel cell having a cathode, an air pump which supplies the cathode with oxygen-containing air, and a CPU which controls operation of elements which constitute the fuel cell system. The CPU determines, depending on situations, whether or not to perform an oxygen-starving process which is a process of starving the cathode of the oxidizer during the normal operation, and stops the air pump when a determination is made to perform the oxygen-starving process.

### BACKGROUND OF THE INVENTION

1. Field of the Invention

The present invention relates to a fuel cell system and a control method therefor, and more specifically to a fuel cell system which supplies oxidizer to a cathode in the fuel cell, and a control method therefor.

2. Description of the Related Art

Conventionally, in the field of fuel cell systems, an oxidizer-starving process (air starvation) is used, which is a process of temporarily stopping or reducing a supply of the oxidizer to the cathode in the fuel cell thereby starving the cathode of the oxidizer.

It is generally known that the output of the fuel cell (electromotive force in particular) increases after an oxidizer-starving process in comparison to the output before the oxidizer-starving process. This can be utilized in different ways. JP-A 63-26961 discloses a technique of performing an oxidizer-starving process in a normal operation when constant power generation is underway, thereby restoring an output of the fuel cell which will otherwise decrease with time.

Also, PCT(WO) 2003-504807 discloses a technique in which an oxidizer-starving process is performed based on the temperature of the fuel cell at start-up time for increased over-voltage (internal resistance) of the fuel cell which leads to an increased amount of heat generation.

However, JP-A 63-26961 discloses nothing about determination criteria for determining whether or not to perform an oxidizer-starving process, nor does it disclose a timing when to perform the oxidizer-starving process. An output (electric power) from the fuel cell decreases during an oxidizer-starving process, which means that performing an oxidizer-starving process and restoring an output of the fuel cell system can lead to a situation where the amount of electric energy increased by the oxidizer-starving process is smaller than the amount of electric energy decreased by the oxidizer-starving process, depending on conditions of the fuel cell system (such as conditions of the electrolyte in the fuel cell). In other words, power generation efficiency of the fuel cell can be decreased by performing an oxidizer-starving process, depending on conditions of the electrolyte in the fuel cell.

The technique disclosed in PCT(WO) 2003-504807 is to perform an oxidizer-starving process at a startup time when output of the fuel cell is not yet stable. This technique attempts to quickly increase the temperature of the fuel cell thereby bringing the fuel cell system quickly into a normal operation where the fuel cell is able to more stably generate power. In other words, the technique described in PCT(WO) 2003-504807 has nothing to do with improving power generation efficiency through restoration of the output of the fuel cell, which will otherwise decrease with time during a normal operation, by performing an oxidizer-starving process.

### SUMMARY OF THE INVENTION

In order to overcome the problems described above, preferred embodiments of the present invention provide a fuel cell system and a control method therefor that reliably improve power generation efficiency of the fuel cell during normal operation.

One preferred embodiment of the present invention provides a fuel cell system which includes a fuel cell having a cathode supplied with oxidizer, an oxidizer supply arranged to supply the cathode with the oxidizer, a determination unit arranged to determine, depending on a situation, whether or not to perform an oxidizer-starving process during a normal operation, and a controller arranged to control operation of the oxidizer supply during the normal operation based on a result of the determination by the determination unit.

Another preferred embodiment of the present invention provides a method of controlling a fuel cell system which supplies oxidizer to a cathode in a fuel cell. The method includes a determining step of determining, depending on a situation, whether or not to perform an oxidizer-starving process during a normal operation, and a controlling step of controlling an amount of supply of the oxidizer to the cathode, based on a result of the determination whether or not to perform the oxidizer-starving process during the normal operation.

In a preferred embodiment of the present invention, during a normal operation, a determination is made whether or not to perform an oxidizer-starving process, depending on the situation. If the determination is for performing an oxidizer-starving process, the oxidizer supply to the cathode is temporarily stopped or reduced from the amount supplied up until then. As described, situations are checked to determine whether or not to perform an oxidizer-starving process, and then the oxidizer-starving process is performed depending on the necessity of the situation. By doing so, it becomes possible to more reliably improve power generation efficiency of the fuel cell during the normal operation.

Preferably, the fuel cell system further includes a first memory arranged to store an output value of the fuel cell before a previous oxidizer-starving process and an output value of the fuel cell after the previous oxidizer-starving process. It is determined whether or not to perform the oxidizer-starving process, based on a result of comparison between the output value of the fuel cell before the previous oxidizer-starving process and the output value of the fuel cell after the previous oxidizer-starving process stored in the first memory. In this case, a determination is made to perform the oxidizer-starving process and the amount of oxidizer supplied to the cathode is controlled when the output of the fuel cell after the previous oxidizer-starving process, which is stored in the first memory, is greater than the output of the fuel cell before the previous oxidizer-starving process by a rate not smaller than a predetermined rate. In other words, a determination to perform an oxidizer-starving process is made when a result of the previous oxidizer-starving process indicates that the amount of increase in electric energy achievable after the oxidizer-starving process is greater than the amount of electric energy unavailable during the oxidizer-starving process. As described, by performing an oxidizer-starving process when there is a positive sign for improved power generation efficiency of the fuel cell, it becomes possible to more reliably improve power generation efficiency of the fuel cell during the normal operation.

Preferably, the fuel cell system also includes a second memory arranged to store an anticipated output value of the fuel cell corresponding to a length of time passed, and it is determined whether or not to perform an oxidizer-starving process, based on a result of comparison between a current output value of the fuel cell and an anticipated output value of the fuel cell stored in the second memory. In this case, a determination is made for performing the oxidizer-starving process and the amount of oxidizer supplied to the cathode is controlled when the current value of the output of the fuel cell is smaller than the anticipated value of output of the fuel cell stored in the second memory. In other words, a determination for performing an oxidizer-starving process is made when a decrease in the output is quicker than a standard time-course output of the fuel cell. Therefore, it becomes possible to avoid unnecessary execution of the oxygen-starving process at a time when there is little need for restoring the output of the fuel cell, and to reduce an undesirable decrease in power generation efficiency of the fuel cell during the normal operation.

Preferably, the fuel cell system further includes a secondary battery electrically connected with the fuel cell and an electric charge detector arranged to detect an amount of charge in the secondary battery. It is determined whether or not to perform an oxidizer-starving process based on the amount of charge in the secondary battery detected by the electric charge detector. The determination is made for performing the oxidizer-starving process and the amount of oxidizer supplied to the cathode is controlled when the amount of charge in the secondary battery is below a predetermined amount, i.e., when the secondary battery must be charged. There is no need for restoring the output of the fuel cell when the amount of charge in the secondary battery is sufficient. Thus, this arrangement avoids unnecessary execution of the oxidizer-starving process, and to reduce risk for undesirable decrease in power generation efficiency of the fuel cell. The arrangement also prevents such disadvantages as premature deterioration of the secondary battery caused by over-charging.

Preferably, the fuel cell system further includes time measuring unit arranged to measure time. It is determined whether or not to perform an oxidizer-starving process, after a measurement by the time measuring unit, following an operation startup, of a predetermined amount of time necessary for transition from the operation startup to the normal operation. As described, by having time measuring unit automatically measure a predetermined amount of time necessary for transition from an operation startup to the normal operation following the operation startup, it becomes possible to eliminate the need for the operator to determine if the fuel cell system has entered its normal operation, thereby reducing the burden on the operator.

In direct methanol fuel cell systems, methanol aqueous solution is directly supplied to the fuel cells so that direct methanol fuel cell systems do not require a reformer, and thus can have a simplified system configuration. For this and other reasons, direct methanol fuel cell systems are preferably used suitably in equipment in which portability is essential or in equipment in which a small size is desired. In order to operate a direct methanol fuel cell system and the equipment including it for a longer time, improvement in fuel cell power generation efficiency is essential. Preferred embodiments of the present invention are capable of improving power generation efficiency of the fuel cell, and therefore particularly effective in direct methanol fuel cell systems which are suitably used in equipment which requires portability as well as other fuel cell systems which supply aqueous solution fuel to fuel cells directly.

When a fuel cell system is used in transportation equipment, the fuel cell system needs to be light and thus needs to be smaller than that used in stationary equipment. For this reason, power generation efficiency of the fuel cell needs to be improved in the application to transportation equipment. Especially when the fuel cell system includes a secondary battery, the secondary battery is usually small and light, and therefore tends to run short of the desired charge. For such a reason as this, it is essential to quickly increase the amount of charge in the secondary battery and thus it is important to improve power generation efficiency of the fuel cell. Therefore, a preferred embodiment of the present invention is suitably used in transportation equipment.

It should be noted here that the term “normal operation” means a state of a fuel cell system in which the fuel cells can generate electricity constantly.

Other features, elements, characteristics, and advantages will be apparent from the following detailed description of preferred embodiments with reference to the attached drawings.

### BRIEF DESCRIPTION OF THE DRAWINGS

FIG. 1 is an illustrative drawing which shows a primary portion of a fuel cell system according to a preferred embodiment of the present invention.

FIG. 2 is a perspective view which shows the fuel cell system mounted on a frame of a motorcycle.

FIG. 3 is an illustrative drawing which shows a primary portion of the fuel cell system.

FIG. 4 is a block diagram which shows an electrical configuration of the fuel cell system.

FIG. 5 is a flowchart showing an example of primary steps after power generation startup of the fuel cell system.

FIG. 6 is a continuation of the flowchart in FIG. 5.

FIG. 7 is a flowchart showing an example of an oxygen-starving process to be performed in the fuel cell system.

FIG. 8 is an illustrative drawing which shows how an output of the fuel cell changes when the oxygen-starving process is performed.

### DETAILED DESCRIPTION OF PREFERRED EMBODIMENTS

Hereinafter, preferred embodiments of the present invention will be described with reference to the drawings.

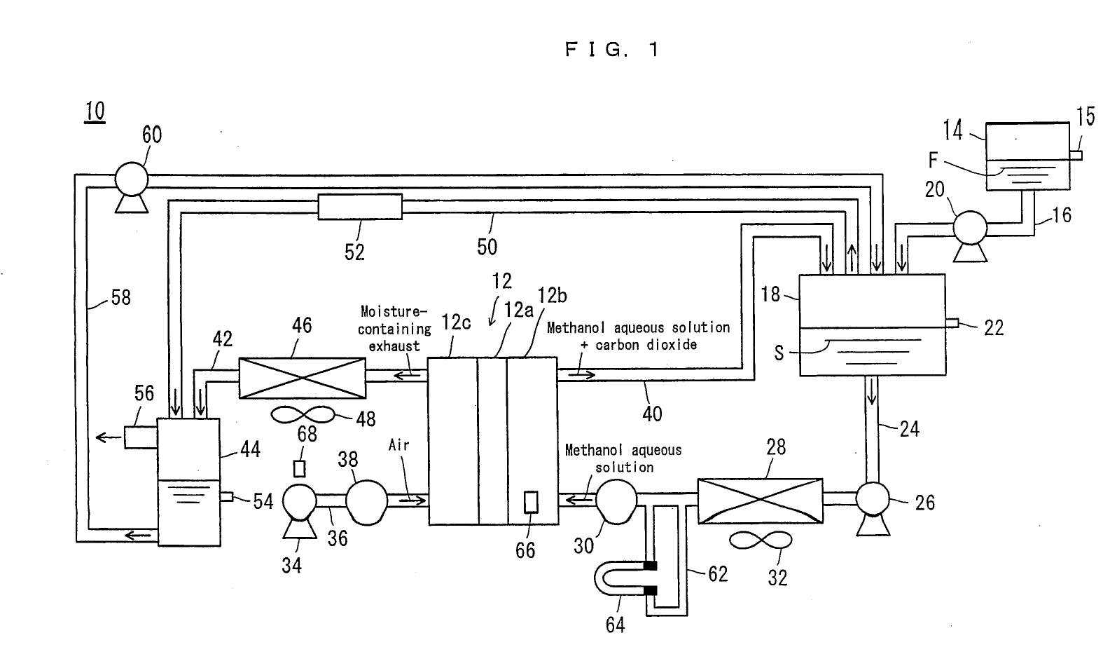

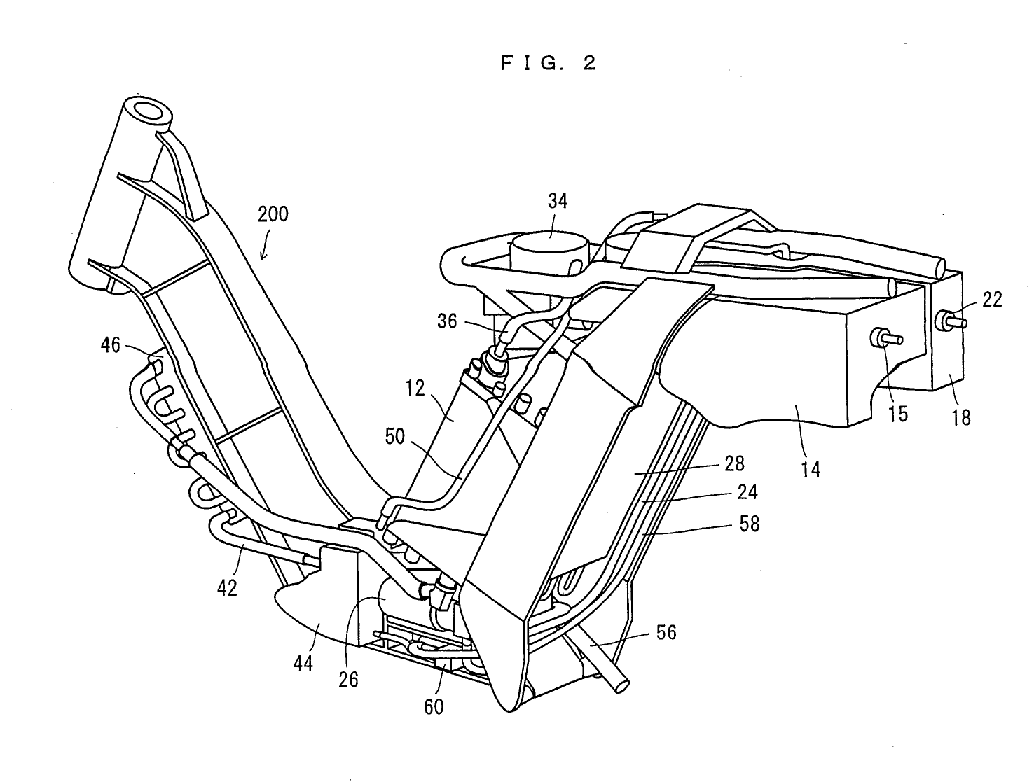

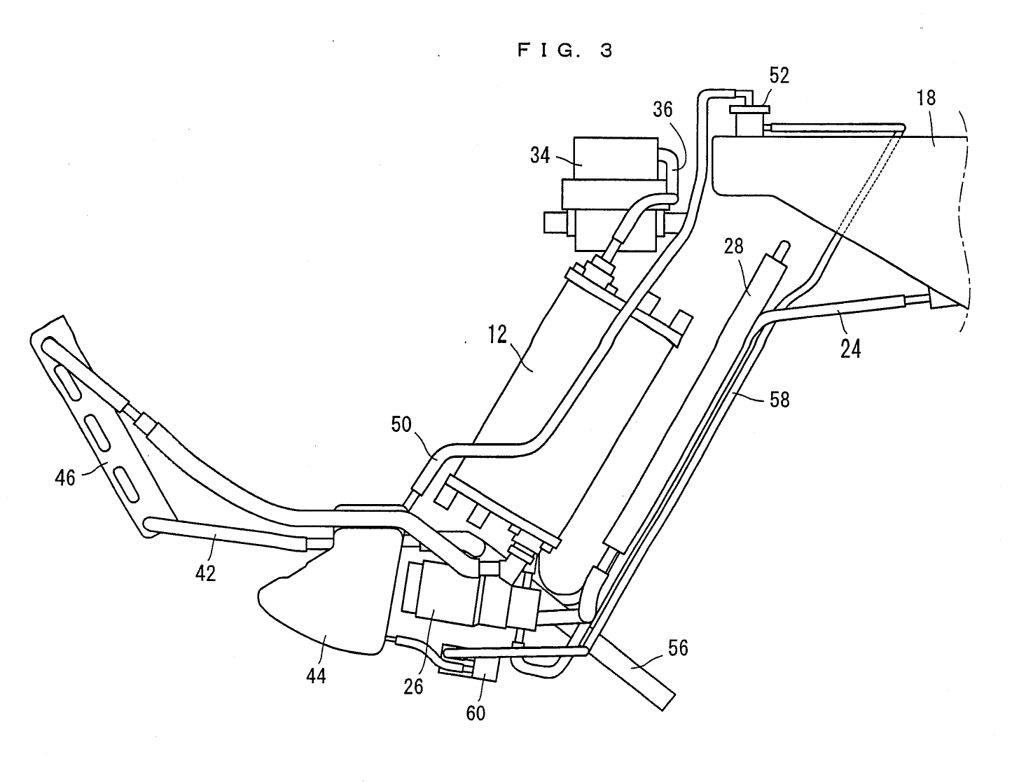

As shown in FIG. 1 through FIG. 4, a fuel cell system 10 according to a preferred embodiment of the present invention is provided as a direct methanol fuel cell system. Direct methanol fuel cell systems do not require a reformer and therefore are used suitably in equipment in which portability is essential and/or a small size is desired. Here, description will be made in which the fuel cell system 10 is used in a motorcycle as an example of transportation equipment. As shown in FIG. 2, the motorcycle will be represented only by a vehicle frame 200, with the left-hand side being the front side of the vehicle and the right-hand side being the rear side thereof in the figure. The fuel cell system 10 is disposed along the vehicle frame 200.

Referring mainly to FIG. 1, the fuel cell system 10 includes a fuel cell 12. The fuel cell 12 is constructed as a fuel cell stack or a plurality of fuel cells connected (laminated) in series, each of which includes an electrolyte 12a provided by a solid polymer film, and an anode (fuel electrode) 12b and a cathode (air electrode) 12c which sandwich the electrolyte 12a.

The fuel cell system 10 includes a fuel tank 14 which holds highly concentrated methanol fuel (aqueous solution containing approximately 50 wt % of methanol) F. The fuel tank 14 is connected, via a fuel supply pipe 16, with an aqueous solution tank 18 which stores methanol aqueous solution S. The fuel supply pipe 16 is provided with a fuel pump 20. The fuel pump 20 supplies the aqueous solution tank 18 with the methanol fuel F from the fuel tank 14.

The fuel tank 14 is provided with a level sensor 15 for detecting the level of methanol fuel F in the fuel tank 14. The aqueous solution tank 18 is provided with a level sensor 22 for detecting the level of methanol aqueous solution S in the aqueous solution tank 18. The aqueous solution tank 18 is connected, via an aqueous solution pipe 24, with the anode 12b of the fuel cell stack 12. The aqueous solution pipe 24 is provided with an aqueous solution pump 26, a radiator 28 serving as a heat exchanger, and an aqueous solution filter 30, respectively from the upstream side. A cooling fan 32 is disposed near the radiator 28 for cooling the radiator 28. The methanol aqueous solution S in the aqueous solution tank 18 is supplied by the aqueous solution pump 26 toward the anode 12b, cooled by the radiator 28 as necessary, and then purified by the aqueous solution filter 30 before being supplied to the anode 12b.

On the other hand, the cathode 12c in the fuel cell 12 is connected with an air pump 34 via an air pipe 36. The air pipe 36 is provided with an air filter 38. Thus, air which contains oxygen (oxidizer) is sent from the air pump 34, purified by the air filter 38 and then supplied to the cathode 12c.

The anode 12b and the aqueous solution tank 18 are connected with each other via a pipe 40, so unused methanol aqueous solution and produced carbon dioxide discharged from the anode 12b are supplied to the aqueous solution tank 18.

Further, the cathode 12c is connected with the water tank 44 via a pipe 42. The pipe 42 is provided with a radiator 46 serving as a gas-liquid separator, and near the radiator 46 is a cooling fan 48 disposed for cooling the radiator 46. Exhaust gas which is discharged from the cathode 12c and contains moisture (water and water vapor) is moved to the water tank 44 via the pipe 42.

The aqueous solution tank 18 and the water tank 44 are connected with each other via the CO2 vent pipe 50. The CO2 vent pipe 50 is provided with a methanol trap 52 which separates methanol aqueous solution S. The carbon dioxide discharged from the aqueous solution tank 18 is thus supplied to the water tank 44.

The water tank 44 is provided with a level sensor 54 which detects the level of water in the water tank 44. The water tank 44 is provided with an exhaust gas pipe 56. The exhaust gas pipe 56 discharges carbon dioxide and the exhaust gas from the cathode 12c.

The water tank 44 is connected with the aqueous solution tank 18 via the water recycling pipe 58. The water recycling pipe 58 is provided with a water pump 60. Water in the water tank 44 is recycled by the water pump 60 to the aqueous solution tank 18 as necessary depending on the situation of the aqueous solution tank 18.

Further, in the aqueous solution pipe 24, a bypass pipe 62 is provided between the radiator 28 and the aqueous solution filter 30.

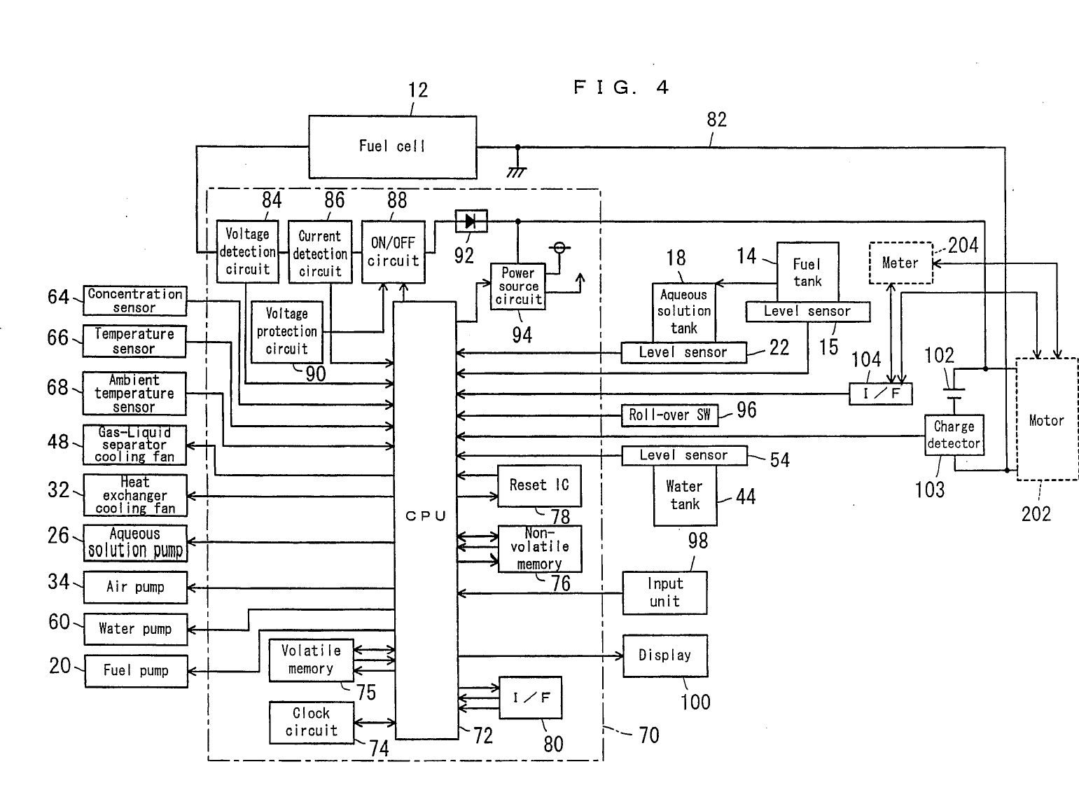

Reference is now made also to FIG. 4. In the fuel cell system 10, the bypass pipe 62 is provided with a concentration sensor 64 for detecting the concentration of methanol aqueous solution S. A cell temperature sensor 66 for detecting the temperature of the fuel cell 12 is attached to the fuel cell 12 whereas an ambient temperature sensor 68 for detecting the ambient temperature is provided near the air pump 34.

As shown in FIG. 4, the fuel cell system 10 includes a control circuit 70.

The control circuit 70 includes a CPU 72 serving as a controller which performs necessary calculations and controls operations of the fuel cell system 10, a clock circuit 74 which gives clock signals to the CPU 72, a volatile memory 75 (e.g., RAM, DRAM or any other suitable memory device) for storing data, such as time passed, based on the clock signals given to the CPU 72, flag data, etc., a non-volatile memory 76 (e.g., EEPROM, CMOS or any other suitable memory device) which stores programs and data necessary for controlling the fuel cell system 10 as well as calculation data etc., a reset IC 78 which prevents malfunction of the fuel cell system 10, an interface circuit 80 for making connections with external devices, a voltage detection circuit 84 which detects voltages in an electric circuit 82 to which the fuel cell 12 is connected to power a motor 202 to drive the motorcycle, an electric current detection circuit 86 which detects values of the electric current flowing in the electric circuit 82, an ON/OFF circuit 88 which opens and closes the electric circuit 82, a voltage protection circuit 90 which prevents over voltage in the electric circuit 82, a diode 92 provided in the electric circuit 82, and a power source circuit 94 which supplies a predetermined voltage to the electric circuit 82.

In the control circuit 70 described above, the CPU 72 is supplied with detection signals from the concentration sensor 64, temperature sensor 66 and the ambient temperature sensor 68 as well as detection signals from the level sensors 15, 22 and 54. Further, the CPU 72 is supplied with detection signals from a roll-over switch 96 which detects whether or not the vehicle has been rolled over, and other signals for making various settings and information entry from an input unit 98.

The CPU 72 controls such components as the fuel pump 20, the aqueous solution pump 26, the air pump 34, the heat-exchanger cooling fan 32, the gas-liquid separator cooling fan 48 and the water pump 60. The CPU 72 also controls a display 100 which displays various information to the motorcycle rider.

In the present preferred embodiment, the CPU 72 preferably serves as a determining unit and a controller. However, any other logic or control unit may serve as the determining unit and the controller. The volatile memory 75 serves as the first memory whereas the non-volatile memory 76 serves as the second memory. Also in the present preferred embodiment, the CPU 72, the clock circuit 74 and the volatile memory 75 are included in the time measuring unit. The oxidizer supply preferably includes the air pump 34, or any other suitable device for supplying air and/or oxygen to the fuel cell.

In the present preferred embodiment, the CPU 72 stores time information based on the clock signals from the clock circuit 74 in the volatile memory 75, whereby a length of time since a certain process has started is measured. The first memory, e.g., the volatile memory 75 stores a value of output from the fuel cell 12 before an oxidizer-starving process (to be described later) and a value of output from the fuel cell 12 after the oxidizer-starving process. In this particular case, the output values before and after an oxidizer-starving process are voltage values, and so the voltage values are stored in the volatile memory 75. The second memory, e.g., the non-volatile memory 76 stores table data of anticipated voltage values and anticipated electrical current values as standard anticipation values for the length of time elapsed. Output (electrical energy) from the fuel cell 12 generally decreases from a value right after the normal operation has started (initial output) by about 10% in 1000 operating hours, for example. The non-volatile memory 76 stores table data of anticipated voltage values and anticipated electrical current values for such a standard time-course output, i.e., table data of anticipated output values showing the standard time-course output.

The fuel cell 12 is connected with a secondary battery 102 and a charge detection device 103 for detecting the amount of electric charge of a secondary battery 102 (a rate of charge with respect to the capacity of secondary battery 102). The secondary battery 102 and the charge detection device 103 are also connected with the motor 202. The secondary battery 102 supplements the output from the fuel cell 12, is charged with electric energy from the fuel cell 12, and discharges to provide the motor 202 and other components with electric energy. The secondary battery 102 can be a Ni—H battery, Lithium ion battery, Ni—Cd battery, etc. Detection signals from the charge detector, e.g., signals from the charge detection device 103, enter the CPU 72.

The motor 202 is provided with a meter 204 which makes measurements for various data concerning the motor 202. These data and status information about the motor 202 measured by the meter 204 are provided to the CPU 72 via the interface circuit 104.

Now, a power generation operation of the fuel cell system will be described. When an unillustrated main switch is turned ON, the fuel cell system 10 begins to drive its components, such as the aqueous solution pump 26 and the air pump 34, and begins power generation (operation).

When power generation is started, methanol aqueous solution S of a desired concentration which is stored in the aqueous solution tank 18 is pumped by the aqueous solution pump 26 toward the fuel cell 12. The solution is cooled as necessary by the radiator 28, purified by the aqueous solution filter 30, and then supplied to the anode 12b. On the other hand, air which contains oxygen as an oxidizer is pumped by the air pump 34 toward the fuel cell 12. The air is first purified by the air filter 38 and then supplied to the cathode 12c.

On the anode 12b in the fuel cell 12, methanol and water in the methanol aqueous solution S react electro-chemically with each other to produce carbon dioxide and hydrogen ions. The hydrogen ions move through the electrolyte 12a to the cathode 12c, where the hydrogen ions react electro-chemically with oxygen in the air which is supplied to the cathode 12c, to produce water (water vapor) and electric energy.

Carbon dioxide created on the anode 12b in the fuel cell 12 flows through the pipe 40, the aqueous solution tank 18, and the CO2 vent pipe 50 to reach the water tank 44, and then it is discharged from the exhaust gas pipe 56.

On the other hand, most of the water vapor created on the cathode 12c in the fuel cell 12 is liquefied and discharged in the form of water, with saturated water vapor being discharged in the form of gas. Part of the water vapor which was discharged from the cathode 12c is cooled and liquefied by lowering the dew point in the radiator 46. The radiator 46 liquefies the water vapor through operation of the cooling fan 48. Moisture (water and water vapor) and unused air from the cathode 12c are supplied to the water tank 44 via the pipe 42. Also, water which has moved to the cathode 12c due to the water crossover is discharged from the cathode 12c and supplied to the water tank 44. Further, water and carbon dioxide which are present at the cathode 12c due to the methanol crossover are discharged from the cathode 12c and supplied to the water tank 44.

It should be noted here that the term water crossover is a phenomenon in which a few mols of water move to the cathode 12c, accompanying the hydrogen ions which occur at the anode 12b and are moving to the cathode 12c. The term methanol crossover is a phenomenon in which methanol moves to the cathode 12c, accompanying the hydrogen ions which move to the cathode 12c. At the cathode 12c, the methanol reacts with air supplied from the air pump 34, and is thereby decomposed into water and carbon dioxide.

Water (fluid) which was collected in the water tank 44 is pumped by the water pump 60 and recycled to the aqueous solution tank 18 as appropriate via the water recycling pipe 58, where it is reused as water in the methanol aqueous solution S.

Generally, in a generating fuel cell, output (especially electromotive force) increases when the cathode is temporarily starved of the oxidizer through an oxidizer-starving process. In the fuel cell system 10, during a normal operation, the oxidizer-starving process (an oxygen-starving process in the present preferred embodiment) is performed by temporarily stopping the supply of air to the cathode 12c, or by temporarily decreasing the supply of air to the cathode 12c from the amount of supply up until then. Through this operation, the fuel cell system 10 restores the output of the fuel cell 12.

Next, description will be given for an example of primary steps after power generation startup of the fuel cell system 10.

Note that in the present preferred embodiment, when the main switch is turned ON, flags 1 through 3 in the volatile memory 75 are in an OFF state. The term “flag” is a piece of information representing ON or OFF, for example, for the CPU 72 to determine the current situation and to perform a step appropriate to the situation. In the present preferred embodiment, the flag 1 is a piece of information for determining if an oxygen-starving process was performed at a past point in time relatively close to the current point in time. The flag 2 is a piece of information for determining if a determination has been made as to the need to perform an oxygen-starving process. The flag 3 is a piece of information for determining if the previous oxygen-starving process helped restore the output. Hereinafter, the following expressions will be used: A “flag is raised” when the flag status is changed from OFF to ON, a “flag is UP” when the flag status is ON, a “flag is lowered” when the flag status is changed from ON to OFF, and a “flag is down” when the flag status is OFF.

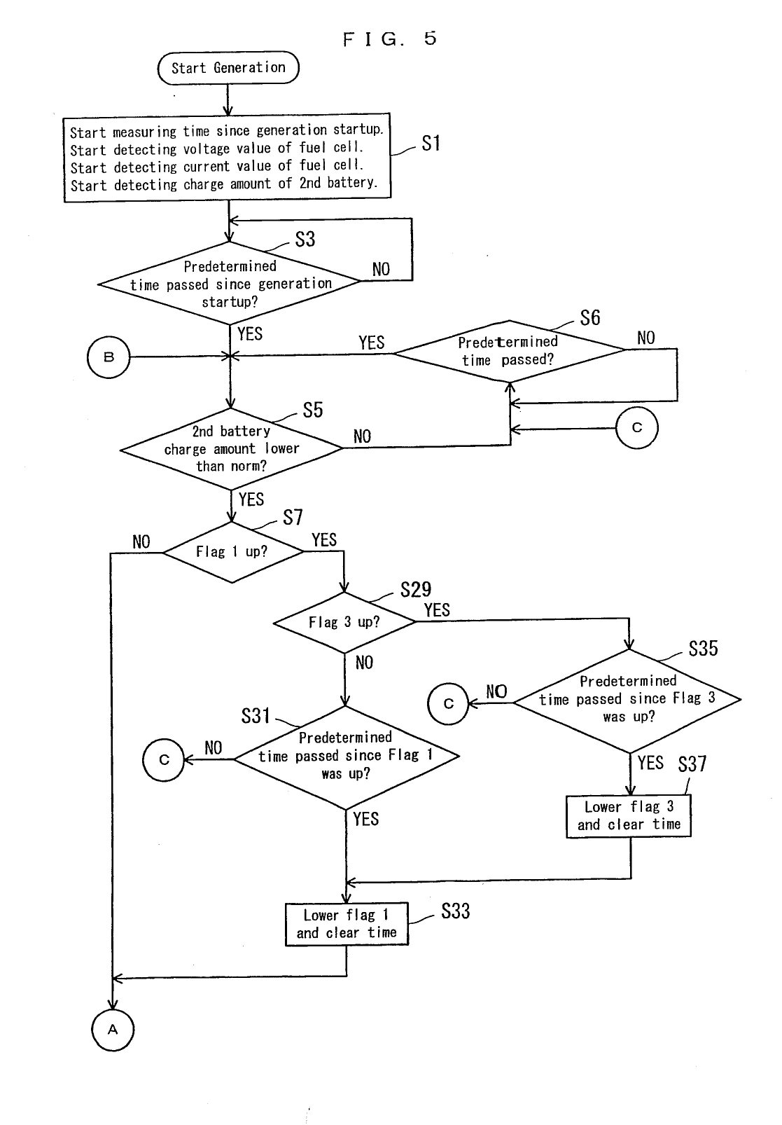

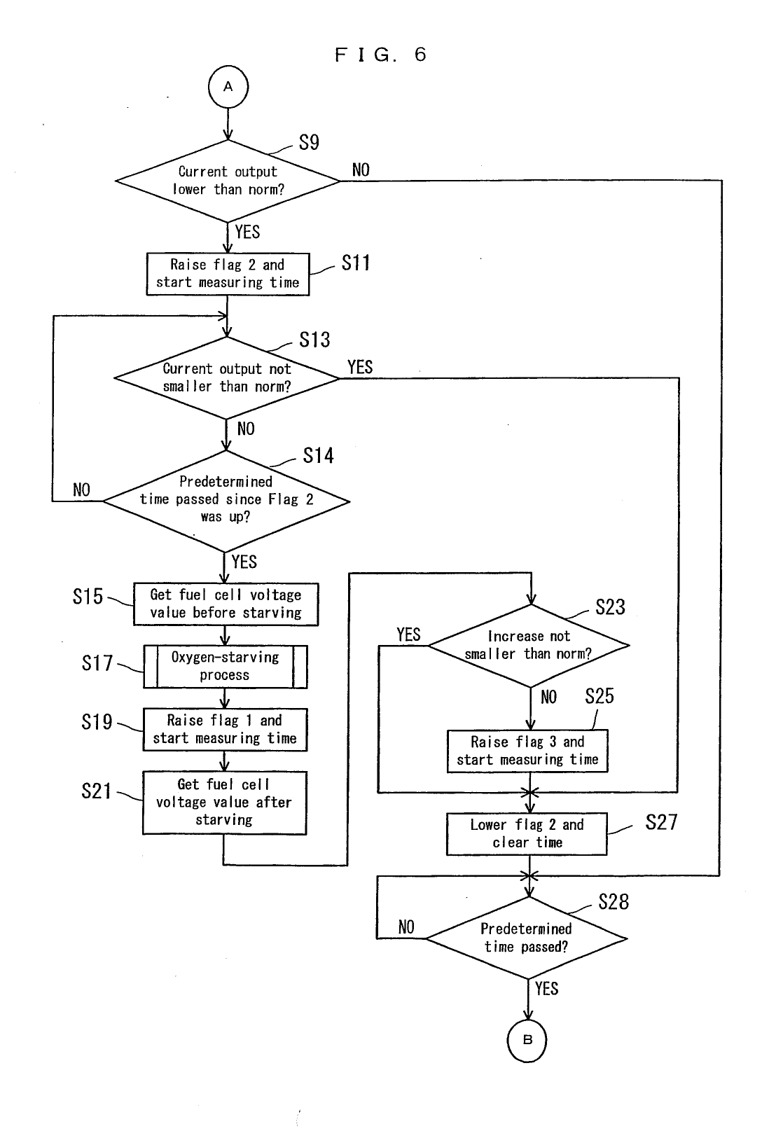

Referring to FIG. 5 and FIG. 6, first, when the main switch is turned ON and power generation (operation) is started, clock signals (pulse signals) from the clock circuit 74 are counted to measure the length of time since the power generation startup. In other words, a measurement of time since the power generation startup is started. Also, detection of a voltage value and an electric current value of the fuel cell 12 is started, and detection by the charge detection device 103 of the amount of electric charge in the secondary battery 102 is started (Step S1).

The time elapsed since the power generation startup is stored in the volatile memory 75. The voltage values detected by the voltage detection circuit 84 and the current values detected by the current detection circuit 86 are each related to the time elapsed since the power generation startup and are stored in the volatile memory 75. Likewise, the amount of charge in the secondary battery 102 detected by the charge detection device 103 is related to the time elapsed since the power generation startup and is stored in the volatile memory 75.

With the above-described arrangement, a determination is made if a predetermined amount of time since the power generation startup (10 minutes, for example) has passed (Step S3). The predetermined amount of time used in Step S3 as a norm is set on the basis of a length of time for the fuel cell 12 from the power generation startup to become able to generate power at a constant and stable output, i.e., a length of time necessary to complete a transition from the power generation startup to the normal operation. This is because no comparison of the current output value to the anticipated output value corresponding to the time elapsed is possible, as will be described later, while the output from the fuel cell 12 is unstable. In other words, the state of the electrolyte 12a cannot be determined from the output of the fuel cell 12 until the normal operation begins since the output from the fuel cell 12 is changing and therefore it is impossible to determine if the oxygen-starving process should be performed or not.

If the predetermined amount of time has not passed since the power generation startup (Step S3: NO), the system waits until the predetermined amount of time has passed. When the predetermined amount of time has passed since the power generation startup (Step S3: YES), and the system is in the normal operation, a determination is made if the current amount of charge in the secondary battery 102 is below a predetermined amount (a rate of 90% charge, for example) in Step S5.

If the current amount of charge in the secondary battery 102 is not smaller than the predetermined amount (Step S5: NO), there is no need for charging the secondary battery 102, or there is no need for restoring the output of the fuel cell 12. Thus, the system waits, starting from the time point when determination was made in Step S5, until a predetermined amount of time (three minutes, for example) has passed until the program Step S6 becomes (YES). Once the predetermined amount of time has passed (Step S6: YES), the program goes to Step S5, where the system detects the current amount of charge in the secondary battery 102 to see if it is below the predetermined amount.

On the other hand, if the current amount of charge in the secondary battery 102 is below the predetermined amount (Step S5: YES), the program checks if an oxygen-starving process has been performed before, i.e., if the flag 1 is up (Step S7). If the flag 1 is down (Step S7: NO), the current output which is based on the current voltage and electric current values is compared to an anticipated output value which is based on the anticipated voltage and current values corresponding to the time elapsed. The system checks if the current output value is below the anticipated output value corresponding to the time elapsed (Step S9).

If the current output value is below the anticipated output value corresponding to the time elapsed (Step S9: YES), i.e., if the current output value is smaller than the standard output value, a flag 2 is raised which indicates that a determination is made for performing an oxygen-starving process, and the measuring of time since the flag 2 has been raised is started (Step S11). Then, the current output value is compared to the anticipated output value corresponding to the time elapsed, to see if the current output value is not lower than the anticipated output value corresponding to the time elapsed (Step S13).

If the current output value is lower than the anticipated output value corresponding to the time elapsed (Step S13: NO), then the system checks if a predetermined amount of time (ten minutes, for example) has passed since the flag 2 was raised (Step S14). If the predetermined amount of time has not passed since the flag 2 was raised (Step S14: NO), the program goes to Step S13, to check again if the current output value is not lower than the anticipated output value corresponding to the time elapsed or not. In other words, as long as Step S13 is (NO) since the flag 2 is raised until the predetermined amount of time has passed, a cycle of comparison between the current output value and the anticipated output value corresponding to the time elapsed is repeated, and a plurality of checks are performed.

If the output value is below the anticipated output value for a predetermined amount of time since the flag 2 is raised (Step S14: YES), a current voltage value is stored in the volatile memory 75 as the voltage value of the fuel cell 12 before the oxygen-starving process (Step S15). Then the oxygen-starving process is performed in order to restore the output of the fuel cell 12 (Step S17). As described, by watching (monitoring) the value of output of the fuel cell and the anticipated value of output from the time when the flag 2 is raised to the time when a predetermined amount of time has passed, it becomes possible to make an accurate determination, which eliminates unnecessary execution of the oxygen-starving process at times when, for example, the voltage value of the fuel cell 12 drops only momentarily below the anticipated voltage value.

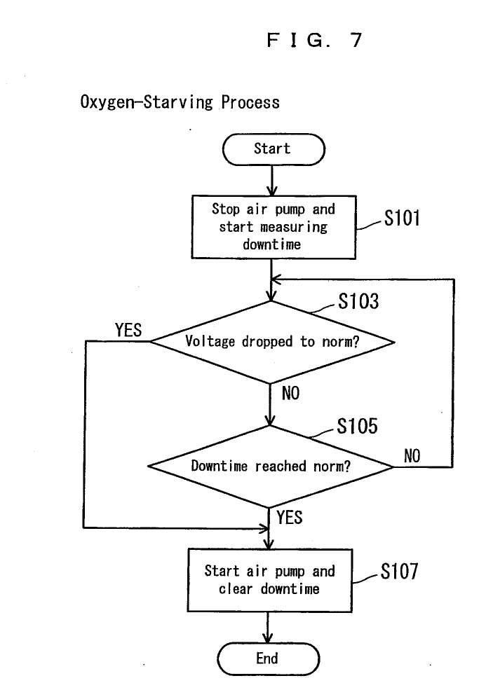

Here, reference will be made to FIG. 7 to describe the oxygen-starving process (air-starving process) in Step 17.

First, the air pump 34 stops to cut the supply of air to the cathode 12c. At the same time, a measurement is started for a downtime of the air pump 34 (Step S101). Note that the anode 12b continues to be supplied with methanol solution S from the aqueous solution pump 26 even after the air pump 34 is stopped.

Then, a comparison is made between a voltage value of the fuel cell 12 and a preset voltage value (such as 5%-60% of the voltage value before oxygen-starving process), to see if the voltage value has dropped down to the preset voltage value (Step S103). If the voltage value has not dropped to the preset voltage value (Step S103: NO), the program checks if the downtime of the air pump 34 has reached a preset time (ten seconds, for example) or not (Step S105).

If the downtime of the air pump 34 has not reached the preset time (Step S105: NO) the program goes to Step S103. If the downtime of the air pump 34 has reached the preset time (Step S105: YES), then the air pump 34 is started to resume the supply of air to the cathode 12c, the downtime of the air pump 34 is cleared (Step S107), and the oxygen-starving process is finished. If the voltage value has dropped to the preset voltage value (Step S103: YES), the program jumps to Step S107 where the oxygen-starving process is finished.

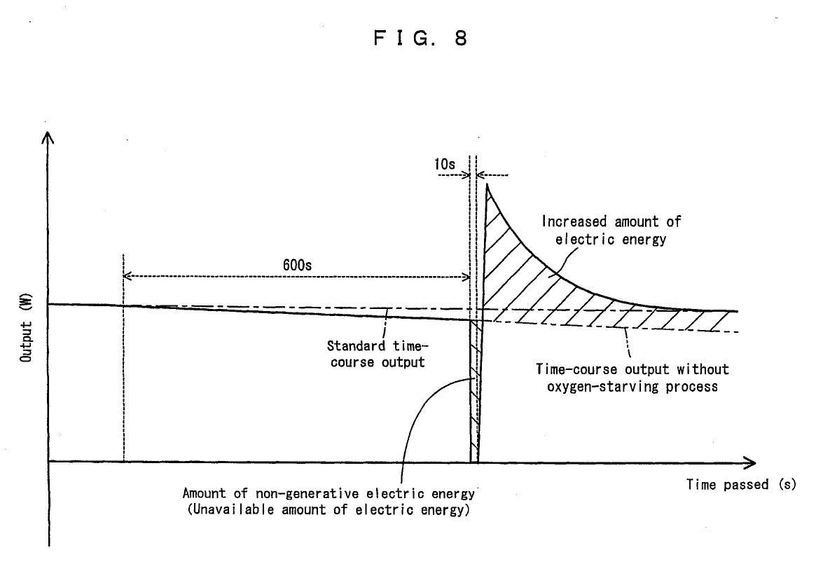

By performing such an oxygen-starving process during normal operation, the output of the fuel cell increases as shown, for example, in FIG. 8. FIG. 8 shows a case in which an amount of increase in electric energy obtained after the oxygen-starving process exceeds an amount of electric energy which cannot be generated during the oxygen-starving process (an amount of electric energy not available during the oxygen-starving process). In other words, FIG. 8 shows a case where an oxygen-starving process improves power generation efficiency of the fuel cell 12. FIG. 8 also shows that the oxygen-starving process is performed when a decrease in output of the fuel cell 12 is quicker than the standard time-course output depicted in an alternate long and short dashed line and when this situation continues for a period of ten minutes.

Returning to FIG. 5 and FIG. 6, upon finishing the oxygen-starving process in Step S17, a flag 1 is raised to indicate that an oxygen-starving process was performed, and a measurement is started for a length of time since the flag 1 has been raised (Step S19). Next, a highest (peak) voltage value detected after the oxygen-starving process is stored in the volatile memory 75 as a voltage value of the fuel cell 12 after the oxygen-starving process (Step S21).

Then, a comparison is made between the voltage value of the fuel cell 12 before the oxygen-starving process and the voltage value of the fuel cell 12 after the oxygen-starving process, to see if the voltage value of the fuel cell 12 increased by a rate not smaller than a predetermined rate (about 5%, for example) as a result of the oxygen-starving process (Step S23). The rate of increase in the voltage value used as a norm in Step S23 is set on the basis of an increase in the electric energy anticipated to be necessary after the oxygen-starving process. Since the increase which is made after the oxygen-starving process is primarily an electromotive force, it is possible to make a generally good estimate of the increased amount of electric energy by comparing the voltage value before the oxygen-starving process and the voltage value after the oxygen-starving process. If the voltage value after the oxygen-starving process has increased over the voltage value before the oxygen-starving process by a rate not smaller than about 5%, it is expected that the an increased amount of electric energy obtained after the oxygen-starving process will exceed the amount of electric energy not available during the oxygen-starving process, as compared to a case depicted in a long dashed double-short dashed line in FIG. 8 which is an output pattern when the oxygen-starving process was not performed. In other words, if the voltage value after the oxygen-starving process has increased over the voltage value before the oxygen-starving process by a rate not smaller than about 5%, it is expected that the power generation efficiency of the fuel cell 12 will be improved.

If the voltage value after the oxygen-starving process has not increased over the voltage value before the oxygen-starving process by not smaller than the predetermined rate (Step S23: NO), a flag 3 is raised to indicate that the next oxygen-starving process can decrease power generation efficiency of the fuel cell 12, and a measurement is started for a length of time since the flag 3 has been raised (Step S25). Then, the flag 2 is lowered, and the time passed since the flag 2 was raised is cleared (Step S27). If the voltage value after the oxygen-starving process has increased over the voltage value before the oxygen-starving process by a rate not smaller than the predetermined rate (Step S23: YES), the program goes to Step S27. Similarly, the program goes to Step S27 if Step S13 finds that the current output value is not smaller than the anticipated output value (if the answer is (YES).

Thereafter, the system checks if a predetermined amount of time (approximately five minutes, for example) has passed since the determination in Step S9 (Step S28). If the predetermined amount of time has passed (Step S28: YES), the program goes to Step S5. If the predetermined amount of time has not passed (Step S28: NO), the system waits until the predetermined amount of time has passed. Also, the program goes to Step 28 if Step S9 finds that the current output value is not smaller than the anticipated output value corresponding to the time elapsed (if the answer is NO).

If Step S7 finds that the flag 1 is up (if the answer is YES), the system checks if the flag 3 is up (Step S29). If the flag 3 is down (Step S29: NO), the program checks if a predetermined amount of time (ten minutes, for example) has passed since the flag 1 was raised (Step S31). If the predetermined amount of time has passed since the flag 1 was raised (Step S31: YES), the flag 1 is lowered, the time passed since the flag 1 was raised is cleared (Step S33), and the program goes to Step S9. If the predetermined amount of time has not passed since the flag 1 was raised (Step S31: NO), then the program goes to Step S6.

On the other hand, if the flag 3 is up (Step S29: YES), the system checks if a predetermined amount of time (thirty minutes, for example) has passed since the flag 3 was raised (Step S35). If the predetermined amount of time has passed since the flag 3 was raised (Step S35: YES), the flag 3 is lowered, the time passed since the flag 3 was raised is cleared (Step S37), and the program goes to Step S33.

If the predetermined amount of time has not passed since the flag 3 was raised (Step S35: NO), the program goes to Step S6. In other words, if a result of the previous oxygen-starving process indicates that the next oxygen-starving process can decrease power generation efficiency of the fuel cell 12, the program goes to Step S6 and avoids performing the oxygen-starving process.

According to the fuel cell system 10 according to a preferred embodiment of the present invention as described above, the decision whether or not to perform an oxygen-starving process is made on the basis of the amount of charge in the secondary battery 102 and a result of comparison between the current output value and an anticipated output value, and the oxygen-starving process is performed when each of these conditions is satisfied. Also, if an oxygen-starving process has been performed before, a result of the previous oxygen-starving process is also considered when determining if an oxygen-starving process should be performed or not, and the oxygen-starving process is performed when each of the conditions is satisfied. Therefore, it becomes possible to avoid unnecessary oxygen-starving processes and oxygen-starving processes which can decrease power generation efficiency of the fuel cell 12, making it possible to improve power generation efficiency of the fuel cell 12 more reliably in normal operation.

Further, an oxygen-starving process is not performed when there is a large amount of charge in the secondary battery 102 (when charge rate is high). This eliminates such problems as deterioration of the secondary battery 102 due to overcharging at an end stage of the charging cycle, and incorrect determination on the timing for termination of the charging cycle for the secondary battery 102.

According to the fuel cell system 10 as described above, since the power generation efficiency can be improved more reliably, it becomes possible to quickly increase the amount of charge in the secondary battery 102 of a motorcycle. This means that a secondary battery 102 of a motorcycle can have a small capacity, and it is possible to use a small and light weight secondary battery 102. Further, a predetermined amount of time which is necessary for transition from power generation startup to normal operation is measured automatically after the power generation startup. This means that there is no need for the rider of a motorcycle to determine if the fuel cell system has entered its normal operation, and thus it is possible to reduce the burden on the rider.

It should be noted that in the above-described preferred embodiments, description was made for a case that a determination whether or not to perform an oxygen-starving process is made on the basis of the amount of charge in the secondary battery 102, a result of comparison between the current output value and an anticipated output value, and a result of previous oxygen-starving process if there has been an previous oxygen-starving process. However, the present invention is not limited to this. For example, the determination whether to perform an oxygen-starving process or not may be based on one of the amount of charge in the secondary battery 102, a result of comparison between the current output value and an anticipated output value, and a result of previous oxygen-starving process, so that the oxygen-starving process is performed if the condition is satisfied.

The fuel cell system 10 can be used not only in motorcycles but also in automobiles, marine vessels and any other transportation equipment or vehicles.

The present invention is also applicable to fuel cell systems which make use of a reformer, or fuel cell systems in which hydrogen is supplied to the fuel cell. Further, the present invention is applicable to small-scale, stationary-type fuel cell systems.

The fuel to be used is not limited to methanol. The present invention is applicable to fuel cell systems which use any alcohol fuel such as ethanol.

The present invention being thus far described and illustrated in detail, it is obvious that the description and drawings only represent an example of the present invention, and should not be interpreted as limiting the invention. The spirit and scope of the present invention is only limited by words used in the accompanied claims.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-12. (canceled)

13. A fuel cell system comprising:
a fuel cell having a cathode supplied with oxidizer;
an oxidizer supply arranged to supply the cathode with the oxidizer;
a determining unit arranged to determine whether or not to perform a process of starving the cathode of the oxidizer during a normal operation of the fuel cell; and
a controller arranged to control operation of the oxidizer supply during the normal operation based on a result of a determination by the determining unit.

14. The fuel cell system according to claim 13, further comprising a first memory arranged to store an output value of the fuel cell before a previous oxidizer-starving process and an output value of the fuel cell after the previous oxidizer-starving process, wherein the determining unit determines whether or not to perform the oxidizer-starving process based on a result of comparison between the output value of the fuel cell before the previous oxidizer-starving process and the output value of the fuel cell after the previous oxidizer-starving process stored in the first memory.

15. The fuel cell system according to claim 14, further comprising a second memory arranged to store an anticipated output value of the fuel cell corresponding to a length of time passed since initial output of the fuel cell system, wherein the determining unit determines whether or not to perform the oxidizer-starving process based on a result of comparison between a current output value of the fuel cell and the anticipated output value of the fuel cell stored in the second memory.

16. The fuel cell system according to claim 13, further comprising a secondary battery electrically connected with the fuel cell, and an electric charge detector arranged to detect an amount of charge in the secondary battery, wherein the determining unit determines whether or not to perform the oxidizer-starving process based on the amount of charge in the secondary battery detected by the electric charge detector.

17. The fuel cell system according to claim 13, further comprising a time measuring unit arranged to measure time following an operation startup, wherein the determining unit determines whether or not to perform the oxidizer-starving process after a predetermined amount of time necessary for transition from the operation startup to the normal operation.

18. The fuel cell system according to claim 13, further comprising an aqueous solution tank, wherein the aqueous fuel tank supplies aqueous fuel solution to the fuel cell directly.

19. Transportation equipment comprising the fuel cell system according to claim 13.

20. A method of controlling a fuel cell system which supplies oxidizer to a cathode in a fuel cell, the method comprising:
determining whether or not to perform a process of starving the cathode of the oxidizer during a normal operation of the fuel cell; and
controlling an amount of supply of the oxidizer to the cathode based on a result of the determination whether or not to perform the oxidizer-starving process during the normal operation.

21. The method of controlling a fuel cell system according to claim 20, wherein the fuel cell system includes a first memory arranged to store an output value of the fuel cell before a previous oxidizer-starving process and an output value of the fuel cell after the previous oxidizer-starving process, and
the determining step includes a step of determining to perform an oxidizer-starving process upon finding the output value of the fuel cell after the previous oxidizer-starving process stored in the first memory is greater than the output value of the fuel cell before the previous oxidizer-starving process by a rate not smaller than a predetermined rate.

22. The method of controlling a fuel cell system according to claim 21, wherein the fuel cell system includes a second memory arranged to store an anticipated output value of the fuel cell corresponding to a length of time passed since initial output of the fuel cell system, and
the determining step includes a step of determining to perform an oxidizer-starving process upon finding a current output value of the fuel cell is smaller than an anticipated output value of the fuel cell stored in the second memory.

23. The method of controlling a fuel cell system according to claim 20, wherein the fuel cell system includes a secondary battery electrically connected with the fuel cell, and
the determining step includes a step of determining to perform an oxidizer-starving process upon finding an amount of electric charge in the secondary battery smaller than a predetermined amount.

24. The method of controlling a fuel cell system according to claim 20, wherein the fuel cell system includes time measuring unit arranged to measure time following an operation startup, and
the determining step includes a step of determining whether or not to perform an oxidizer-starving process after a predetermined amount of time necessary for transition from the operation startup to the normal operation.
